(19) United States
(12) Patent Application Publication
(10) Pub. No.: US 2018/0075235 A1
(43) Pub. Date: Mar. 15, 2018

(54) Abnormality Detection System and Abnormality Detection Method

(71) Applicant: Hitachi, Ltd., Tokyo (JP)

(72) Inventors: Yoshiyuki TAJIMA, Tokyo (JP); Susumu SERITA, Tokyo (JP); Masami YAMASAKI, Tokyo (JP)

(21) Appl. No.: 15/495,213

(22) Filed: Apr. 24, 2017

(30) Foreign Application Priority Data
Sep. 14, 2016 (JP) 2016-179146

(51) Int. Cl. G06F 21/55

(52) U.S. Cl. CPC G06F 21/554; G06F 2221/034

(57) ABSTRACT

An abnormality detection system is configured to (a) convert, based on a prescribed rule, a time-sequential event included in a log output by a monitoring target system into a symbolized event; (b) learn, based on a normal-time log symbolized in (a), a symbolized event sequence, which appears in a same pattern, as a frequently-appearing pattern; and (c) detect an occurrence or a nonoccurrence of an abnormality, based on whether not the frequently-appearing pattern is occurring in a monitoring-time log symbolized in (a).

### CROSS-REFERENCE TO PRIOR APPLICATION

This application relates to and claims the benefit of priority from Japanese Patent Application number 2016-179146, filed on Sep. 14, 2016 the entire disclosure of which is incorporated herein by reference.

### BACKGROUND

The present invention generally relates to a technique for detecting an abnormality of a target system.

A wide variety of information communication services and social infrastructure services are supported by systems constituted by a large number of computers, various devices, and equipment of various types. These services are large-scale and complex services constructed to provide more convenient services and realize high-level optimization. In addition, in order to meet demands for cost reduction, flexible software updating, and the like, such systems are often constructed by combining hardware and software provided by different companies or OSS (Open Source Software). The inside of such systems is likely to become a black box which impose a large burden on operation monitoring.

Software for monitoring operations of a system provides a search function, a function for checking conformance or nonconformance to a prescribed rule, and the like in order to reduce the burden shouldered by an operation supervisor.

However, the amount of data to be monitored is enormous and a large amount of unnecessary data ends up being detected unless rules are designed based on an understanding of characteristics of the data. In other words, a heavy load is imposed on appropriately designing rules.

Japanese Patent Application Laid-open No. 2012-94046 discloses a technique for detecting an abnormality by comparing an arrangement of events included in a log and an arrangement of pattern information indicating characteristics of a log during normal time with each other to identify inconsistent parts between the log and a normal-time pattern, and determining whether or not a degree of inconsistency between the log and the normal-time pattern exceeds a prescribed threshold based on the identified inconsistent parts.

### SUMMARY

When managing a plurality of servers of a data center, a log in which a certain event series is interrupted by another single event or a different event series must be set as a monitoring target. The reason for this is as follows. At a data center, different software on servers cooperate with each other to perform processing in accordance with various objectives. For example, when a standard operation such as a transaction for registering data in a DB is performed, a plurality of servers separately write a log related to a series of transactions. In this case, using software for monitoring, collecting, and integrating logs such as fluentd and Zabbix, logs of the plurality of servers are time-sequentially integrated into a single log and then analyzed.

However, since various software output logs in different contexts, when time-sequentially integrating a plurality of logs, a certain event series ends up being interrupted by another event series.

The technique disclosed in Japanese Patent Application Laid-open No. 2012-94046 does not anticipate situations where a certain event series is interrupted by another event series as described above. Therefore, the technique disclosed in Japanese Patent Application Laid-open No. 2012-94046 handles a part interrupted by another event as an inconsistent part. In other words, the technique disclosed in Japanese Patent Application Laid-open No. 2012-94046 is incapable of correctly determining whether or not an abnormality has occurred as a whole when there is an inconsistent part caused by an interruption by another event series even though a sequence in a certain event series is consistent.

In consideration thereof, an object of the present invention is to provide a system which detects an abnormality in a monitoring target system from a log in which a plurality of event series coexist.

An abnormality detection system which detects an abnormality of a monitoring target system according to an embodiment is configured to:

(a) convert, based on a prescribed rule, a time-sequential event included in a log output by the monitoring target system into a symbolized event;

(b) learn, based on a normal-time log symbolized in (a), a symbolized event sequence, which appears in a same pattern, as a frequently-appearing pattern; and

(c) detect an occurrence or a nonoccurrence of an abnormality, based on whether not the frequently-appearing pattern is occurring in a monitoring-time log symbolized in (a).

According to the present invention, an abnormality in a monitoring target system can be detected from a log in which a plurality of event series coexist.

### BRIEF DESCRIPTION OF THE DRAWINGS

FIG. 1 shows a configuration example of an abnormality detection system;

FIG. 2 shows a configuration example of hardware of a computer;

FIG. 3 shows an example of a log before integration;

FIG. 4 shows an example of a log after integration;

FIG. 5 shows an example of template data;

FIG. 6 shows an example of a symbolized event;

FIG. 7 shows an example of a frequently-appearing series pattern;

FIG. 8 shows an example of a monitoring target pattern;

FIG. 9 shows an example of abnormality detection result data;

FIG. 10 is a flow chart showing an example of a process of a monitoring target selection and model learning phase;

FIG. 11 is a flow chart showing an example of a template generation process;

FIG. 12 is a flow chart showing an example of a window size determination process;

FIG. 13 shows an example of a frequency distribution of event numbers from start to end of an occurrence of a rest pattern;

FIG. 14 is a flow chart showing a modification of a determination process of a window size of a rest pattern;

FIG. 15 is a flow chart showing an example of a monitoring phase process;

FIG. 16 shows an example of a log information monitoring screen;

FIG. 17 shows an example of a tracking information display screen; and

FIG. 18 shows an example of an abnormality detection frequency display screen.

### DETAILED DESCRIPTION

Hereinafter, an embodiment will be described. While a “program” is sometimes used as a subject when describing a process in the following description, since a program causes prescribed processing to be performed while using at least one of a storage resource (for example, a memory) and a communication interface device as appropriate when being executed by a processor (for example, a CPU (Central Processing Unit)), a processor or an apparatus including the processor may be used as a subject of processing. Processing performed by a processor may be partially or entirely performed by a hardware circuit. A computer program may be installed from a program source. The program source may be a program distribution server or a storage medium (for example, a portable storage medium).

### <Outline>

An abnormality detection system according to the present embodiment detects, from a log of devices, computers, or a system (referred to as a “monitoring target system”) constituted by computers and related devices or equipment which support an information communication service or a social infrastructure service, whether or not an abnormality is occurring in the monitoring target system. Accordingly, the abnormality detection system supports stable operation of a system related to such services. The log may be a set of events including messages expressed by a time and date, a text, numerical values, or the like.

Processes of the abnormality detection system may be divided into a monitoring target selection and model learning phase and a monitoring phase.

In the monitoring target selection and model learning phase, a monitoring target is selected based on a frequently-appearing series pattern from a normal-time log output by the monitoring target system, and a predictive model for performing a prediction of the frequently-appearing series pattern is learned.

In the monitoring phase, when there is a deviation between a prediction result of an occurrence of the frequently-appearing series pattern that is a monitoring target with respect to a monitoring-time log and an event sequence of a log which has actually occurred, an abnormality is determined and, accordingly, a notification is made and related information is displayed to a user.

In the monitoring target selection and model learning phase, the following processes A1 to A5 may be executed.

(A1) Based on a text process or a clustering process, a normal-time log described by a text, numerical values, and the like is converted into a symbol string.

(A2) A frequently-appearing series pattern is extracted from the symbolized event sequence. In other words, a frequently-appearing series pattern refers to a pattern of an event sequence (an order of events) which frequently appears during normal time.

(A3) A partial pattern constituted by a partial element string of an element string constituting the frequently-appearing series pattern is generated. In other words, a partial pattern refers to a pattern of an event sequence (an order of events) which constitutes a portion of a frequently-appearing series pattern.

(A4) A partial pattern used for monitoring is selected from a set of pairs of the frequently-appearing series pattern extracted in A2 and the partial pattern generated in A3. This selection method will be described later. When selecting the partial pattern used for monitoring, a window size used to monitor an occurrence of a partial pattern in the frequently-appearing series pattern (referred to as a “window size of a partial pattern”) and a window size used to monitor a pattern (referred to as a “rest pattern”) from the occurrence of the partial pattern to an occurrence of an end of the frequently-appearing series pattern (referred to as a “window size of a rest pattern”) are determined.

(A5) Based on the generated frequently-appearing series pattern and partial pattern and the normal-time log, a statistical predictive model for calculating a probability of occurrence of the frequently-appearing series pattern including the partial pattern when the partial pattern occurs is learned.

In the monitoring phase, an abnormality is detected from a log based on the patterns and the model learned in the learning phase. In addition, in the monitoring phase, an operation supervisor is presented with a detection result, related information, and the like. In the monitoring phase, an abnormality may be determined when all of the following requirements B1 to B3 are satisfied.

(B1) A partial pattern occurs in a range of a window size of the partial pattern.

(B2) After the occurrence of the partial pattern, a probability of occurrence of a frequently-appearing series pattern including the partial pattern in a range combining the window size of the partial pattern and a window size of a rest pattern is equal to or higher than a prescribed threshold.

(B3) A frequently-appearing series pattern including the partial pattern does not occur after the occurrence of the partial pattern.

In other words, in the monitoring phase, an abnormality is determined when a frequently-appearing series pattern which should occur during a normal time does not occur.

In an abnormality determination process, the following processes C1 to C3 may be executed.

(C1) A monitoring-time log is converted into a symbol string in a similar manner as described earlier.

(C2) Abnormality detection is performed with respect to the log using each pattern selected in the monitoring target selection and model learning phase. For example, a determination is made as to whether or not all of the requirements B1 to B3 described above are satisfied.

(C3) A result of the detection is notified and related information is displayed.

Moreover, while a log according to the present embodiment is a set of messages expressed by a time and date, a text, numerical values, or the like, any kind of log may be adopted.

For example, pattern recognition may be performed on an image or a sound obtained using a camera, a microphone, or the like and an extracted tag (annotation) or an extracted sentence may be adopted as an event of a log.

### <System Configuration>

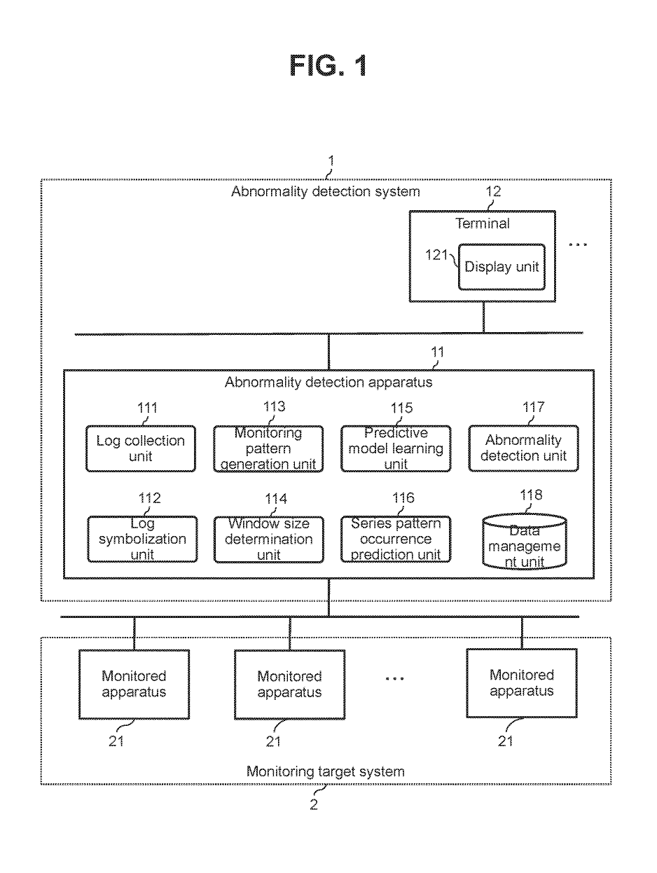

FIG. 1 shows a configuration example of an abnormality detection system according to the present embodiment.

The abnormality detection system 1 includes an abnormality detection apparatus 11 and a terminal 12. The abnormality detection apparatus 11 detects whether or not an abnormality is occurring in a monitoring target system 2 based on a frequently-appearing series pattern extracted from a log. The terminal 12 displays a result of the detection.

The abnormality detection apparatus 11 and the terminal 12 may be connected to each other by a network such as a LAN (Local Area Network). The monitoring target system 2 may include one or more monitored apparatuses 21. Each monitored apparatus 21 may be connected by a network such as a LAN or a WAN.

Moreover, each subsystem may be connected via another network such as a WAN (Wide Area Network) typified by the WWW (World Wide Web).

The number of each component described above may be increased or reduced. The respective components may be connected by a single network or may be connected in a hierarchized manner.

For example, the abnormality detection apparatus 11 may be constituted by a plurality of apparatuses or may be realized on same hardware as the terminal 12. For example, one or more monitored apparatuses 21 may share hardware with the abnormality detection apparatus 11 or the terminal 12.

### <Functions and Hardware>

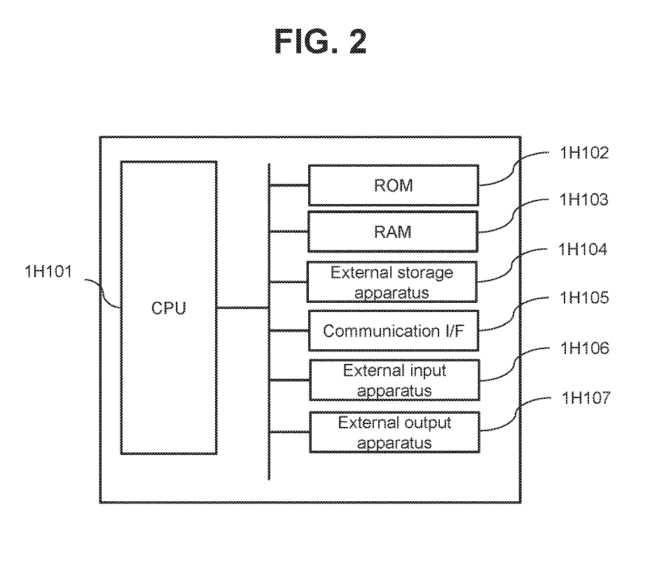

FIG. 2 shows a configuration example of hardware of a computer. Hereinafter, functions of the abnormality detection system 1 will be described with reference to FIGS. 1 and 2.

The abnormality detection apparatus 11 may include, as functions, a log collection unit 111, a log symbolization unit 112, a monitoring pattern generation unit 113, a window size determination unit 114, a predictive model learning unit 115, a series pattern occurrence prediction unit 116, an abnormality detection unit 117, and a data management unit 118. These functions may be realized when a CPU 1H101 included in the abnormality detection apparatus 11 loads a program stored in a ROM (Read Only Memory) 1H102 or an external storage apparatus 1H104 onto a RAM (Read Access Memory) 1H103 and controls a communication I/F (Interface) 1H105, an external input apparatus 1H106 typified by a mouse and a keyboard, and an external output apparatus 1H107 typified by a display.

The terminal 12 includes a display unit 121 as a function.

This function may be realized when a CPU included in the terminal 12 loads a program stored in a ROM or an external storage apparatus onto a RAM and controls a communication I/F (Interface), an external input apparatus typified by a mouse and a keyboard, and an external output apparatus typified by a display.

The monitored apparatus 21 includes, as functions, a log collection function and various functions in accordance with an objective (for example, data management, web page hosting, and equipment control) of each apparatus. These functions may be realized when a CPU included in the monitored apparatus 21 loads a program stored in a ROM or an external storage apparatus onto a RAM and controls a communication I/F, an external input apparatus typified by a mouse and a keyboard, and an external output apparatus typified by a display.

### <Data Structure>

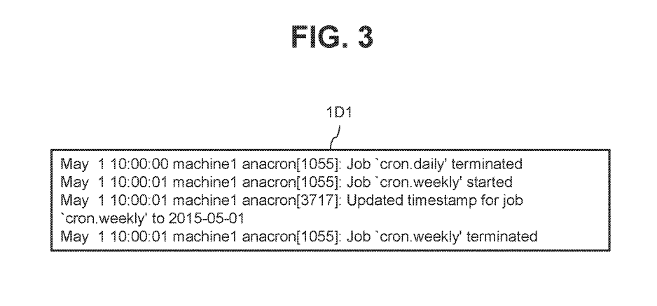

FIG. 3 shows an example of a log 1D1 before integration. The log 1D1 before integration may be collected by the abnormality detection apparatus 11 from the monitoring target system 2.

The log 1D1 may include one or more events. FIG. 3 shows an example of a “syslog” output in an OS such as BSD or Linux (registered trademark).

An event may be constituted by a time and date of generation of the event, a name of a data source having issued the event, and a short text representing contents of the event. In addition, an importance (info, error, or the like) of the event may be associated. In the case of a syslog or a web server log, one row corresponds to one event as shown in FIG. 3. Alternatively, a plurality of rows may correspond to a single event. In the present embodiment, information of a portion excluding the time and date of an event will be referred to as a “message” regardless of a descriptive format of a log.

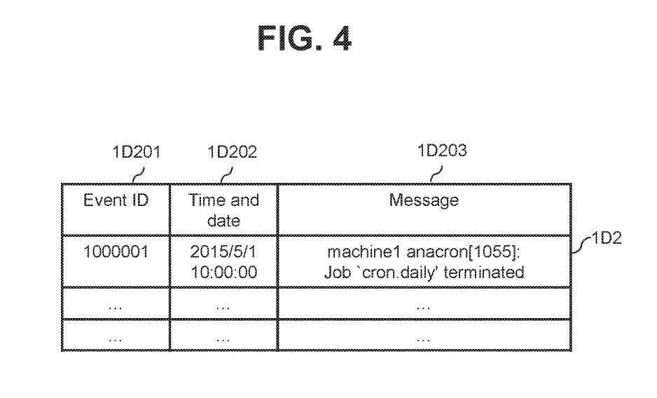

FIG. 4 shows an example of a log after integration. As the log after integration, a plurality of the logs 1D1 collected by the abnormality detection apparatus 11 from the monitoring target system 2 may be integrated by the data management unit 118.

An event in the log after integration may include, as data items, an event ID 1D201, a time and date 1D202, and a message 1D203.

The event ID 1D201 represents a value for uniquely identifying the event after integration. The log collection unit 111 may associate the event ID 1D201 with each event when collecting a log from the monitored apparatus 21.

The time and date 1D202 represents a time and date of generation of the event. The log collection unit 111 may unify the time and date 1D202 into a common format such as ISO 8601 to enable times and dates to be readily compared with each other.

The message 1D203 represents contents of an event having occurred at the time and date 1D202.

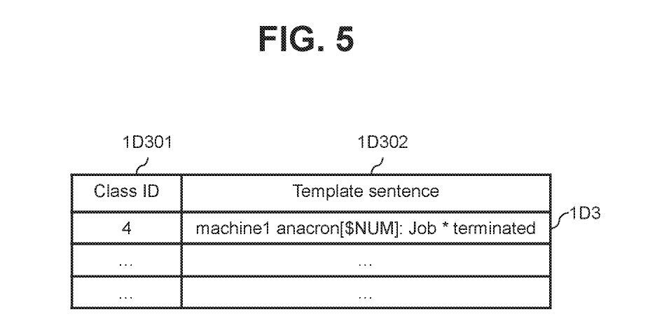

FIG. 5 shows an example of template data 1D3. The template data 1D3 may be managed by the data management unit 118.

The template data 1D3 is used when symbolizing an event. The template data 1D3 may include, as data items, a class ID 1D301 and a template sentence 1D302.

The class ID 1D301 represents a value for uniquely identifying the template data 1D3. The class ID 1D301 may be associated with a symbolized event. In other words, any of the class IDs 1D301 is associated with a symbolized event.

The template sentence 1D302 represents a sentence for abstracting a similar message 1D203. The template sentence 1D302 may be a sentence in which a part of the message 1D203 is expressed by a wildcard.

In the example shown in FIG. 5, “*” represents an arbitrary character string and “$NUM” signifies a wildcard matching a numerical value. Alternatively, an event can be symbolized depending on whether or not a message matches a regular expression or whether not a message includes a specific group of character strings. Therefore, the template sentence 1D302 may also be a sentence expressing such a regular expression or a group of character strings.

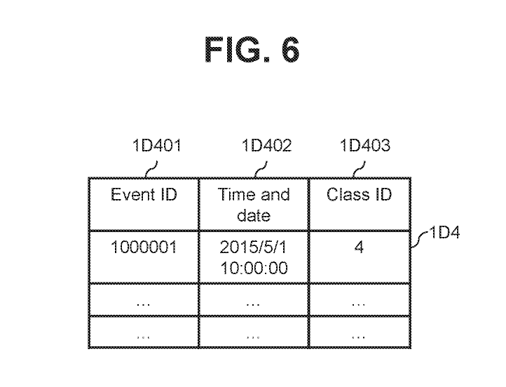

FIG. 6 shows an example of a symbolized event 1D4. The symbolized event 1D4 may be managed by the data management unit 118.

The symbolized event 1D4 represents data after converting an event into a symbol string. The symbolized event 1D4 may include, as data items, an event ID 1D401, a time and date 1D402, and a class ID 1D403.

The class ID 1D403 represents the class ID 1D301 of the template data 1D3 associated with an event having the event ID 1D401. When an event is symbolized at the same time as collecting a log, the number of symbolized events 1D4 is consistent with the number of events 1D2 in a log after integration.

In the example shown in FIG. 6, a class ID 1D403 of “4” is associated with an event of which the event ID 1D401 is “1000001”. This indicates that the message 1D203 of the event of which the event ID 1D401 is “1000001” is a message conforming to a template sentence 1D302 “machinel anacron[$NUM]:Job * terminated” which corresponds to the class ID 1D301 “4” shown in FIG. 5.

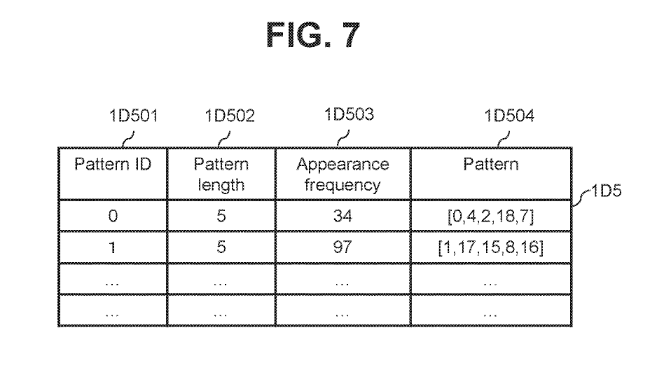

FIG. 7 shows an example of a frequently-appearing series pattern 1D5. The frequently-appearing series pattern 1D5 may be managed by the data management unit 118.

The frequently-appearing series pattern 1D5 may be obtained by applying series pattern mining to the symbolized event 1D4 related to a normal-time log. The frequently-appearing series pattern 1D5 may include, as data items, a pattern ID 1D501, a pattern length 1D502, an appearance frequency 1D503, and a pattern 1D504.

The pattern ID 1D501 represents a value for uniquely identifying the frequently-appearing series pattern 1D5.

The pattern length 1D502 represents the number of class IDs included in the pattern 1D504.

The appearance frequency 1D503 represents a frequency of occurrence of the pattern 1D504 in a normal-time log.

The pattern 1D504 represents a set of class IDs time-sequentially and frequently appearing in a normal-time log.

FIG. 7 shows that a frequently-appearing series pattern with a pattern ID 1D501 of “0” is a pattern in which class IDs time-sequentially appear in a sequence of “0→4→2→18→7” (1D504). FIG. 7 also shows that the pattern 1D504 with the pattern ID 1D501 of “0” is constituted by five (1D502) class IDs and has occurred 34 times (1D503) in a normal-time log.

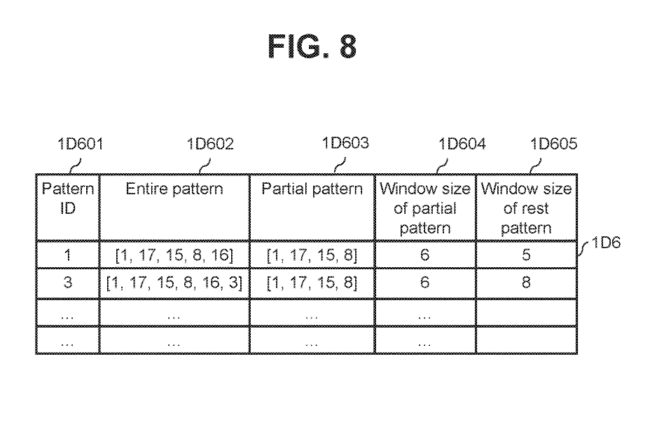

FIG. 8 shows an example of a monitoring target pattern 1D6.

The monitoring target pattern 1D6 may be managed by the data management unit 118.

The monitoring target pattern 1D6 includes a frequently-appearing series pattern to become a monitoring target and a partial pattern included in the frequently-appearing series pattern (referred to as a “partial pattern”). The monitoring target pattern 1D6 may include, as data items, a pattern ID 1D601, an entire pattern 1D602, a partial pattern 1D603, a window size of a partial pattern 1D604, and a window size of a rest pattern 1D605.

The pattern ID 1D601 and the entire pattern 1D602 respectively correspond to the pattern ID 1D501 and the pattern 1D504 of the frequently-appearing series pattern 1D5 shown in FIG. 7.

The partial pattern 1D603 represents a pattern included in a part of the entire pattern 1D602.

The window size of a partial pattern 1D604 represents a section used to monitor an occurrence of the partial pattern 1D603. The window size of a partial pattern 1D604 may be an event number that is a monitoring target or a monitoring time (for example, 10 seconds or 1 minute).

The window size of a rest pattern 1D605 represents a section used for monitoring after the occurrence of the partial pattern 1D603. The window size of a rest pattern 1D605 may also be an event number that is a monitoring target or a monitoring time.

In a first row in FIG. 8, the entire pattern 1D602 is “1→17→15→8→16”, the partial pattern 1D603 is “1→17→15→8”, and the rest pattern is “16”. Therefore, when the partial pattern 1D603 “1→17→15→8” occurs in a section of which the window size ID604 of a partial pattern is “6 events”, it may be determined that the partial pattern has occurred. In addition, when the rest pattern “16” occurs after the occurrence of the partial pattern in a section of the window size of a rest pattern 1D605 of “5 events”, it may be determined that the rest pattern has occurred.

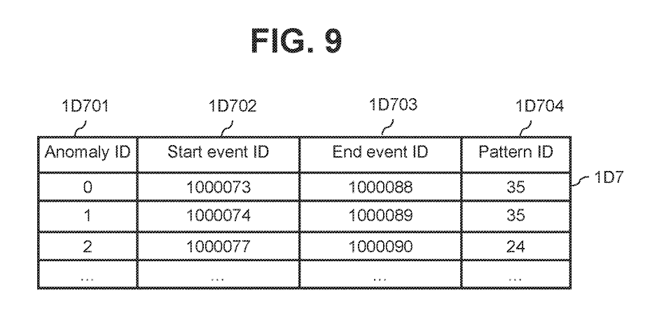

FIG. 9 shows an example of abnormality detection result data 1D7. The abnormality detection result data 1D7 may be managed by the data management unit 118.

The abnormality detection result data 1D7 represents data representing a result of abnormality detection. The abnormality detection result data 1D7 may include, as data items, an anomaly ID 1D701, a start event ID 1D702, an end event ID 1D703, and a pattern ID 1D704.

The anomaly ID 1D701 represents a value for uniquely identifying a result of abnormality detection.

The start event ID 1D702 and the end event ID 1D703 represent event IDs of a start and an end of a section in which an abnormality is detected.

The pattern ID 1D704 represents the pattern ID 1D601 of the monitoring target pattern 1D6 used for the abnormality detection.

In a first row in FIG. 9, a result of abnormality detection of which the anomaly ID 1D701 is “0” indicates that, in a section from the start event ID 1D702 “1000073” to the end event ID 1D703 “1000088”, an abnormality related to the pattern ID 1D704 “35” is detected. Moreover, since an abnormality is detected by sliding the window, an abnormality related to the pattern ID “35” is similarly detected during the anomaly ID 1.

The data management unit 118 may manage parameters of predictive models. In this case, the data management unit 118 may include a data structure for managing parameters appropriately corresponding to predictive models. A recurrent neural network may be used to generate a predictive model. In this case, a parameter of the model is a set of weight matrices.

### <Processing Flow>

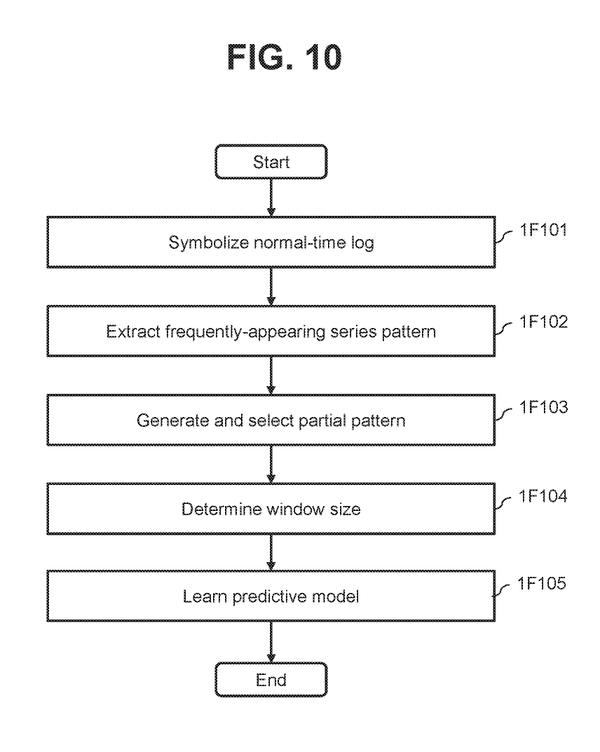

FIG. 10 is a flow chart showing an example of a process of a monitoring target selection and model learning phase.

It is assumed that, prior to the present process, the abnormality detection apparatus 11 has collected normal-time logs from the monitored apparatus 21 and has already registered a log after integration (refer to FIG. 4) in the data management unit 118.

First, the log symbolization unit 112 symbolizes each event 1D2 of a normal-time log after integration using the template data 1D3 and generates a symbolized event 1D4 (step 1F101).

The method of generating a template will be described later.

Moreover, the log symbolization unit 112 may assume that an event 1D2 not corresponding to any template data 1D3 is an unknown event and may allocate a suitable symbol indicating an unknown event such as “−1” to the event.

Next, the monitoring pattern generation unit 113 applies frequently-appearing series pattern mining such as Prefixspan or Apriori All to the symbolized event and extracts a pattern of which an appearance frequency is equal to or larger than a threshold “C” (in other words, a frequently-appearing series pattern) (step 1F102). While the threshold “C” is set to “30 times” in the present embodiment, the threshold “C” may be appropriately set in accordance with a log to be monitored or a purpose.

Next, the monitoring pattern generation unit 113 extracts all partial patterns from the frequently-appearing series pattern.

In addition, the monitoring pattern generation unit 113 extracts partial patterns of which “an occurrence frequency of the frequently-appearing series pattern/an occurrence frequency of the partial pattern” is equal to or larger than a threshold a and selects a shortest partial pattern from the extracted partial patterns. Furthermore, the monitoring pattern generation unit 113 registers the selected partial pattern in the monitoring target pattern 1D6 (step 1F103). At this point, since the window size of a partial pattern 1D604 and the window size of a rest pattern 1D605 are unknown, values representing an invalid window size such as “−1” may be adopted. In addition, while the threshold a is set to “0.95” in the present embodiment, the threshold a may be appropriately set in accordance with a log to be monitored or a purpose. By selecting such a partial pattern, an occurrence of a frequently-appearing series pattern can be predicted at a relatively early time point and with relatively high accuracy.

Moreover, while a single pair of a partial pattern and a frequently-appearing series pattern is selected in order to reduce the number of monitored patterns in the present embodiment, two or more pairs may be selected.

Next, the window size determination unit 114 determines the window size of a partial pattern 1D604 and the window size of a rest pattern 1D605 and registers the window sizes in the monitoring target pattern 1D6 (step 1F104). A method of determining a window size will be described later.

Next, using the generated frequently-appearing series pattern and partial pattern and the normal-time log, the predictive model learning unit 115 learns a statistical predictive model for calculating a probability of occurrence of the frequently-appearing series pattern when the partial pattern occurs. In addition, the predictive model learning unit 115 registers a parameter related to the learned predictive model in the data management unit 118 (step 1F105). Subsequently, the present process is ended.

For example, a predictive model constituted by an LSTM (Long short-term Memory) which is a type of a recurrent neural network is used. For example, in a recurrent neural network, a class ID of a certain event having a 1-of-K representation is used as input and a class ID of a next event having a 1-of-K representation is used as output. In addition, a network is configured from an input side by a fully-connected layer, an LSTM layer, an LSTM layer, an LSTM layer, and a fully-connected layer, and output is finally obtained via a soft-max function. The configuration of the network may be appropriately set in accordance with a log to be monitored or a purpose. A parameter related to a predictive model may be a set of weight matrices of each layer.

Alternatively, other methods may be used. For example, an identification model such as a direct logistic regression or an SVM (Support Vector Machine) may be used. For example, each class ID of events from a certain event as a base point to an event which precedes the certain event by i-number of events is used as input. In addition, a determination is made on whether or not a frequently-appearing series pattern that is a monitoring target has occurred (“0” or “1”) during a section from an event following the event set as the base point to an event following a period corresponding to the window size of a rest pattern after the event set as the base point. An appropriate value such as “10” may be set as “τ”.

Furthermore, “the occurrence frequency of the frequently-appearing series pattern/the occurrence frequency of the partial pattern” similar to the case of step 1F103 can be used as a simple predictive model. The predictive model may be appropriately selected in accordance with a log to be monitored or a purpose.

This concludes the description of the process of the monitoring target selection and model learning phase. By first symbolizing an event and then setting a frequently-appearing series pattern in the symbolized event as a monitoring target as is the case of the present embodiment, events can be handled in the same manner regardless of whether the events are represented by a character string or by a numerical value.

Furthermore, by allowing “skips” when extracting a frequently-appearing series pattern, for example, even when a single event or an event of another transaction slips into event series related to a certain transaction, the frequently-appearing series pattern can be extracted as a same pattern.

Moreover, a rule may be defined to limit frequently-appearing series patterns to be registered. For example, a rule of not registering specific patterns which obviously do not occur due to a change in system configuration may be defined.

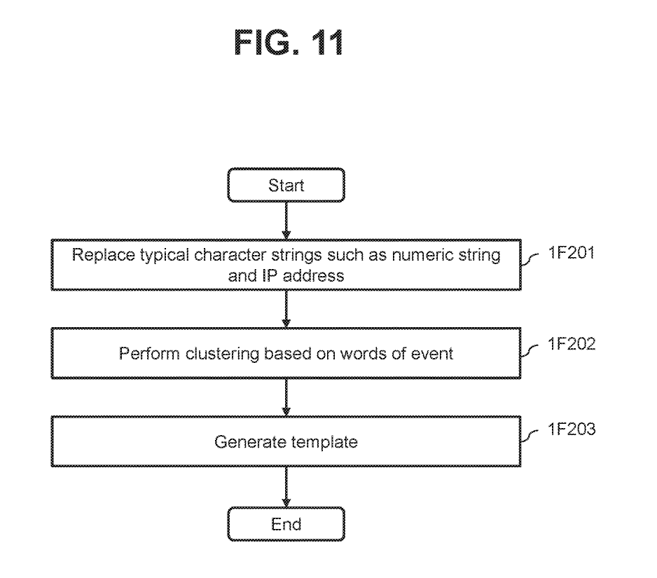

FIG. 11 is a flow chart showing an example of a template generation process.

It is assumed that, prior to the present process, the abnormality detection apparatus 11 has collected normal-time logs from the monitored apparatus 21 and has already registered a log after integration (refer to FIG. 4) in the data management unit 118.

First, the log symbolization unit 112 replaces typical character strings such as a “numeric string”, an “IP address”, a “URI”, and a “MAC address” in each event 1D2 in a normal-time log after integration with character strings such as “$NUM”, “$IPADDR”, “$URI”, and “$MACADDR” (step 1F201).

The log symbolization unit 112 clusters each event using a Ward method based on a Jaccard distance of a group of words included in the event (step 1F202). A cluster may be defined so as to connect in a range where a distance is equal to or less than a specified value (for example, 0.5). In addition, an appropriate number of clusters may be determined based on an information criterion or the like.

The log symbolization unit 112 extracts a longest common subsequence of a group of events to which a same cluster number is allocated using a dynamic programming method (Smith-Waterman algorithm) or the like. In addition, for each event, when a character string exists between respective elements of the longest common subsequence, the log symbolization unit 112 adds a wildcard (*) between corresponding characters of the longest common subsequence to generate a template.

Furthermore, the log symbolization unit 112 registers a class ID for identifying the template in the template data 1D3 using serial numbers from “0” or the like and ends the present process (step 1F203).

Moreover, while clustering is performed in the present embodiment using a Ward method based on a Jaccard distance of a group of words of a log, other methods may be used. For example, a common group of words shared by events belonging to a same cluster may be extracted as a representative word group and a cluster may be allocated based on a distance from the representative word group. In this case, the representative word group becomes a template and an event which is distant from all clusters may be allocated to an unknown event.

Alternatively, words may be converted into vector expressions by “skipgram”, “GloVe”, or the like, a vector obtained by adding up the vector expressions may be adopted as a vector expression of an event, and the vector may be clustered by K-means to generate a class ID.

In addition, the template generation described above assumes a log mainly constituted by a text such as “syslog” in which all numerical values are converted into “$NUM”. However, an appropriate bin may be set with respect to numeric data to create a frequency distribution and an ID of a bin corresponding to a numerical value in each log may be allocated as a class ID. For example, a class ID “1” may be allocated to numerical values “1 to 10” and a class ID “2” may be allocated to numerical values “11 to 20”.

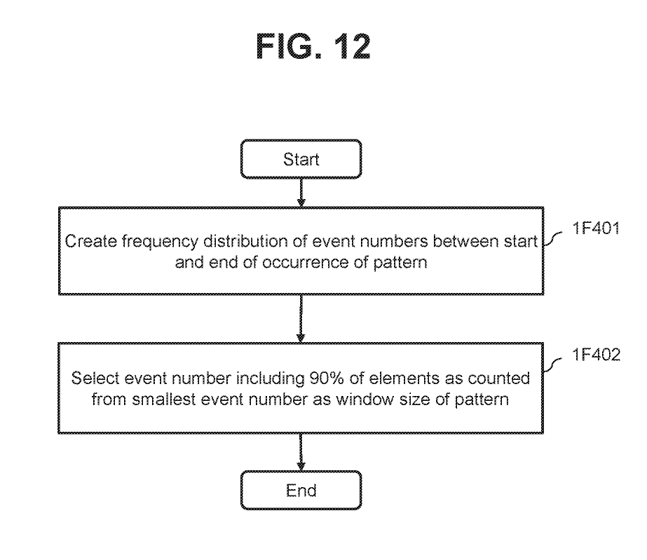

FIG. 12 is a flow chart showing an example of a process of determining a window size.

First, a process of determining a window size of a partial pattern will be described with reference to FIG. 12.

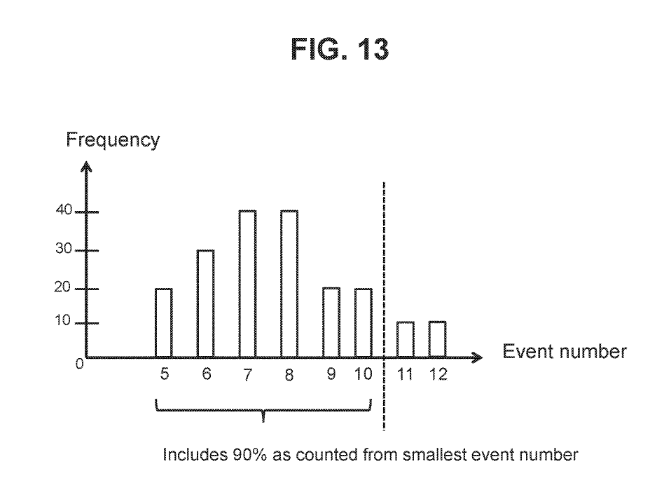

As in the example shown in FIG. 13, the window size determination unit 114 creates a frequency distribution based on event numbers in a section from start to end of occurrences of a plurality of partial patterns (step 1F401).

Next, the window size determination unit 114 determines an event number at a point where, for example, 90% of elements are included as counted from a smallest event number (90 percentile) in the created frequency distribution as a window size of a partial pattern. In addition, the window size determination unit 114 registers the determined window size in the monitoring target pattern 1D6 and ends the process (step 1F402). In the example shown in FIG. 13, since the pattern occurs in event numbers “5 to 12” and the event number including 90% of elements from the smallest event number is “10”, “10” is determined as the window size of a partial pattern.

Moreover, while a window size is determined using event numbers in the description given above, actual time points of a log may be used or a combination of an actual time point of a log and an event number may be used.

In addition, in the description given above, a window size is defined as an event number including 90% of elements from the smallest event number (90 percentile). Alternatively, a partial pattern may be applied to a statistical model such as a log-normal distribution and an integer value nearest to an “average” or “average+3×standard deviation” of the log-normal distribution may be determined as a window size. In addition, a subset may be created by eliminating outliers from a frequency distribution of window sizes and a maximum length value in the subset may be determined as a window size.

Next, a process of determining a window size of a rest pattern will be described with reference to FIG. 12.

As in the example shown in FIG. 13, the window size determination unit 114 creates a frequency distribution based on event numbers in a section from start to end of occurrences of a plurality of rest patterns (step 1F401).

Next, the window size determination unit 114 determines an event number at a point where, for example, 90% of elements are included as counted from a smallest event number (90 percentile) in the created frequency distribution as a window size of a rest pattern. In addition, the window size determination unit 114 registers the determined window size in the monitoring target pattern 1D6 and ends the process (step 1F402).

Accordingly, for each partial pattern and each rest pattern which are monitoring targets, a window size which takes interruption by another even into consideration is determined.

Moreover, while a window size is determined using event numbers in the description given above, actual time points of a log may be used or a combination of an actual time point of a log and an event number may be used.

In addition, in the description given above, a window size is defined as an event number including 904 of elements from the smallest event number (90 percentile). Alternatively, a partial pattern may be applied to a statistical model such as a log-normal distribution and an integer value nearest to an “average” or “average+3×standard deviation” of the log-normal distribution may be determined as a window size. In addition, a subset may be created by eliminating outliers from a frequency distribution of window sizes and a maximum length value in the subset may be determined as a window size.

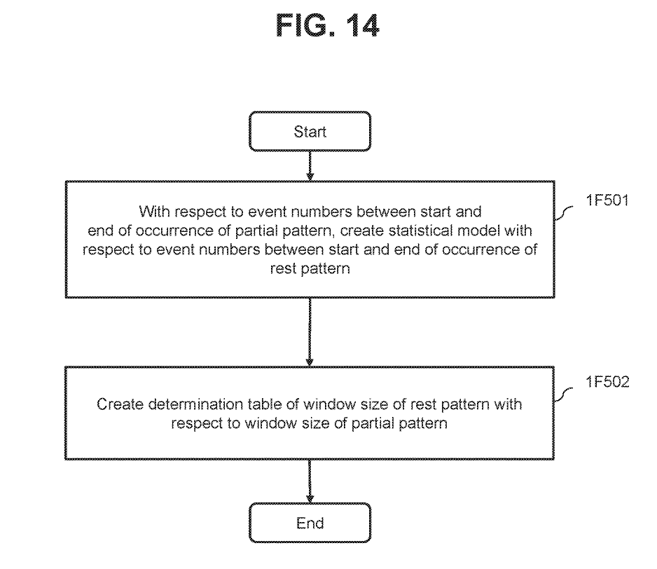

FIG. 14 is a flow chart showing a modification of a process of determining a window size of a rest pattern.

The window size determination unit 114 creates a statistical model (for example, a linear regression model) based on event numbers in a section from start to end of occurrences of a plurality of partial patterns and event numbers in a section from start to end of occurrences of a plurality of rest patterns (step 1F501).

Next, the window size determination unit 114 creates a determination table of a window size of a rest pattern corresponding to a window size of a partial pattern (step 1F502).

In this case, the window size dynamically changes in accordance with event numbers in a section from start to end of occurrences of a plurality of partial patterns. Therefore, the determination table created in step 1F502 may be retained instead of the window size of a rest pattern 1D605 of the monitoring target pattern 1D6 and a window size of a rest pattern may be determined by appropriately referring to the determination table. Accordingly, when a window size of a partial pattern increases due to occurrences of a large number of interrupts, a window size of a rest pattern increases correspondingly.

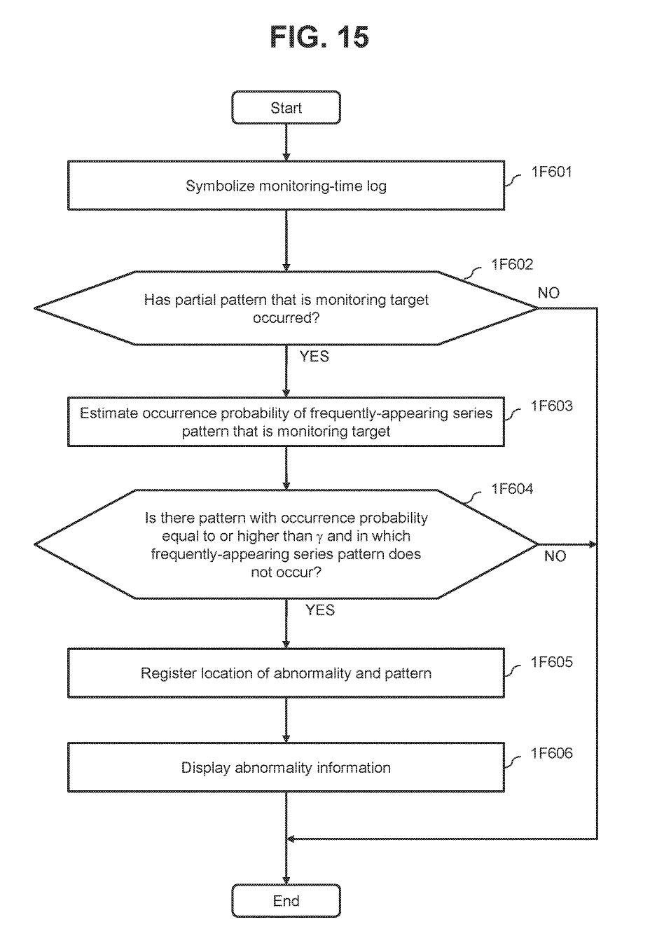

FIG. 15 is a flow chart showing an example of a process of a monitoring phase.

It is assumed that, prior to the present process, the abnormality detection apparatus 11 has collected monitoring-time logs from the monitored apparatus 21 and has already registered a log after integration (refer to FIG. 4) in the data management unit 118. It is also assumed that selection of a monitoring target and model learning have already been performed on normal-time logs.

First, the log symbolization unit 112 symbolizes monitoring-time logs in a similar manner to the monitoring target selection and model learning phase (1F601).

Next, for each pattern selected as a monitoring target in the monitoring-time logs, the series pattern occurrence prediction unit 116 determines whether or not a partial pattern has occurred (step 1F602). When the series pattern occurrence prediction unit 116 determines that a partial pattern has not occurred (NO), the series pattern occurrence prediction unit 116 ends the present process, but when the series pattern occurrence prediction unit 116 determines that a partial pattern has occurred (YES), the series pattern occurrence prediction unit 116 advances to step 1F603.

When a result of the determination in step 1F602 is YES, the series pattern occurrence prediction unit 116 calculates an occurrence probability of a frequently-appearing series pattern including the partial pattern determined to have occurred (step 1F603).

In the present embodiment, for example, an occurrence probability is estimated as described below using a predictive model related to an LSTM which is a type of a recurrent neural network.

First, an internal state of a recurrent neural network is initialized and then updated by inputting a class ID of an event at a time point of occurrence of a partial pattern from several ten time points preceding the occurrence of the time point.

Subsequently, samples are sequentially generated in correspondence with a window size of a rest pattern from a time point following a time point at which the occurrence of the partial pattern had ended. In other words, when a class ID at a certain time point is input to the recurrent neural network, an occurrence probability of each class ID at a next time point is obtained. By performing a roulette selection using the occurrence probability, a next predicted class ID is output. This process is repeated a plurality of times to obtain a plurality of predicted class ID strings (class ID strings of a predicted rest pattern) corresponding to the window size of a rest pattern.

Subsequently, a frequency of occurrences of the frequently-appearing series pattern that is a monitoring target is counted in a class string obtained by concatenating the class ID string of the partial pattern and the class ID string of each predicted rest pattern.

Finally, by dividing the frequency by the total number of predicted rest patterns, the occurrence probability of the frequently-appearing series pattern can be estimated.

The use of an LSTM which is a type of a recurrent neural network enables information prior to the window size of a partial pattern that is a monitoring target to be additionally considered in a natural way and may improve prediction accuracy. Moreover, when a processing load needs to be reduced, the portion of the roulette selection described above may be modified so that a class ID having maximum probability is selected and samples are created only once.

Next, with respect to the pattern in which the partial pattern had occurred in step 1F602, the abnormality detection unit 117 determines whether or not the occurrence probability is equal to or higher than a threshold “y” and a rest pattern occurs in the window size of a rest pattern or, in other words, whether or not the frequently-appearing series pattern set as the monitoring target in combination with the partial pattern occurs. As a result of the determination, when the occurrence probability is equal to or higher than the threshold “y” and a pattern in which the frequently-appearing series pattern does not occur exists (YES), the present process advances to step 1F605. When the result of the determination is negative (NO), the present process is ended (step 1F604). Moreover, while the threshold “y” is set to “0.95” in the present embodiment, the threshold may be set to another value depending on required performance (precision and recall).

When the result of the determination in step 1F604 is YES, the abnormality detection unit 117 determines that an abnormality has occurred in relation to the pattern. In this case, the abnormality detection unit 117 extracts an event ID of a location where the abnormality had occurred or, more specifically, an event ID at a start location of the partial pattern (start event ID) and an event ID at a location advanced by the window size of a rest pattern from an end location of the partial pattern (end event ID).

In addition, while associating the anomaly ID 1D701 with each detected data, the abnormality detection unit 117 registers the start event ID and the end event ID described above as well as the pattern ID in the abnormality detection result data 1D7 (step 1F605).

Furthermore, the abnormality detection unit 117 notifies the display unit 121 of the terminal 12 that an abnormality detection result has been registered in the abnormality detection result data 1D7 (step 1F606) and ends the present process.

Upon receiving the notification, the display unit 121 of the terminal 12 may data of the various logs and patterns as well as the abnormality detection result data 1D7. In other words, the terminal 12 may present the abnormality detection result to the operation supervisor.

### <User Interface>

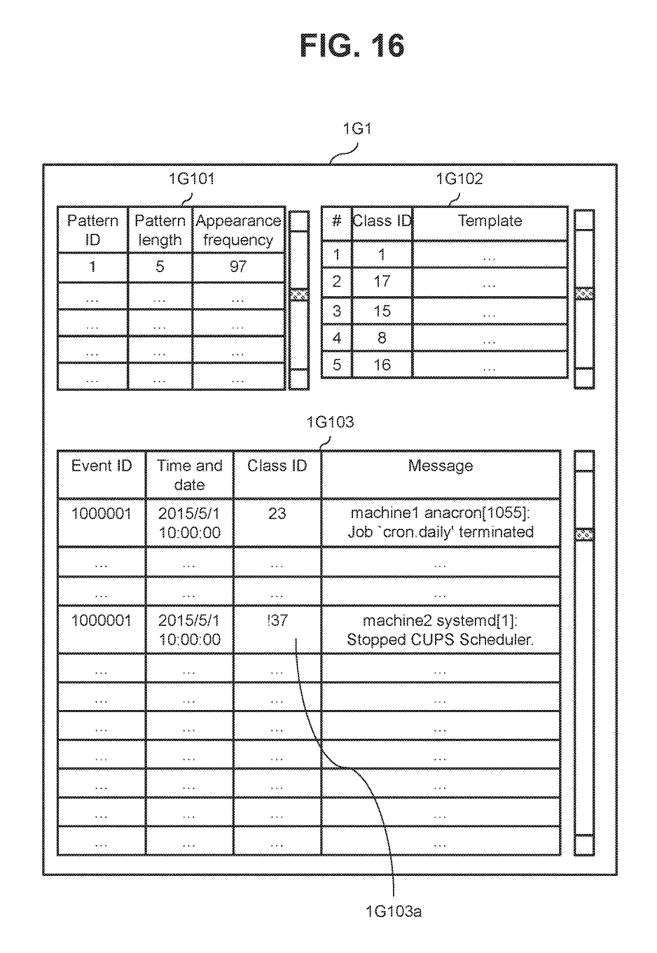

FIG. 16 shows an example of a log information monitoring screen 1G1. The log information monitoring screen 1G1 may be displayed by the display unit 121 of the terminal 12.

The log information monitoring screen 1G1 may display a pattern list 1G101, a template list 1G102, and a log list 1G103.

The pattern list 1G101 may display the pattern ID 1D501, the pattern length 1D502, and the appearance frequency 1D503 of the frequently-appearing series pattern 1D5 which appears in a log that is a monitoring target.

The template list 1G102 may display the template data 1D3 corresponding to the pattern 1D504 of the frequently-appearing series pattern 1D5 selected from the pattern list 1G101.

Displaying these pieces of information enables the operation supervisor to assess what kind of frequently-appearing series pattern is set as a monitoring target for abnormality detection and what kind of log the frequently-appearing series pattern may match.

The log list 1G103 may display an event ID, a time and date, a class ID, and a message corresponding to the event 1D2 and the symbolized event 1D4. In doing so, the class ID of an event in which an abnormality is detected may be highlighted or an additional symbol may be attached thereto as in the case of “!37” denoted by 1G103a in FIG. 16. In addition, a link to an abnormality tracking information display screen 1G2 to be described later may be associated with the class ID.

Accordingly, the operation supervisor can readily learn in which event an abnormality has been detected.

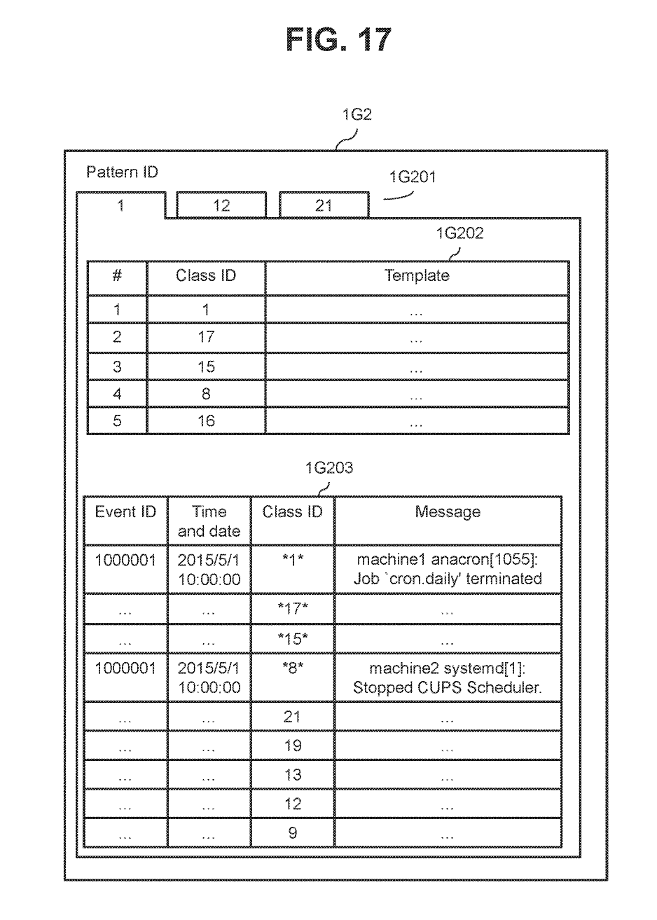

FIG. 17 shows an example of a tracking information display screen 1G2. The tracking information display screen 1G2 may be displayed by the display unit 121 of the terminal 12.

The screen shown as an example in FIG. 17 may be a screen linked to the event in which an abnormality has been detected on the log information monitoring screen 1G1 described above.

In other words, the screen shown as an example in FIG. 17 may display contents of the abnormality of the link source.

The tracking information display screen 1G2 may be separated by an abnormality pattern ID selection tab 1G201. Each portion separated by the tab may display a template list 1G202 and a log list 1G203 of a vicinity of a location of abnormality detection.

The abnormality pattern ID selection tab 1G201 may be generated in a number corresponding to the number of pattern IDs of monitoring target patterns in which an abnormality has been detected. The example shown in FIG. 17 shows that abnormalities related to patterns with pattern IDs “1”, “12”, and “21” have been detected. The tabs differ from each other in the pattern in which an abnormality has been detected as well as displayed contents.

The template list 1G202 may display a list of class IDs and templates related to a monitoring target pattern in which an abnormality has been detected.

The log list 1G203 of a vicinity of a location of abnormality detection displays events in a section from a start event ID to an end event ID of the abnormality detection result data 1D7. The example shown in FIG. 17 displays events with class IDs “1”, “17”, “15”, and “8” corresponding to the partial pattern with the pattern ID “1” and five subsequent events corresponding to the window size of a rest pattern.

Moreover, from the perspective of time-sequential abnormality detection based on a frequently-appearing pattern, the class ID of an event corresponding to a frequently-appearing series pattern may be highlighted or an additional symbol may be attached thereto as in the case of “*1*” and “*17*” shown in FIG. 17.

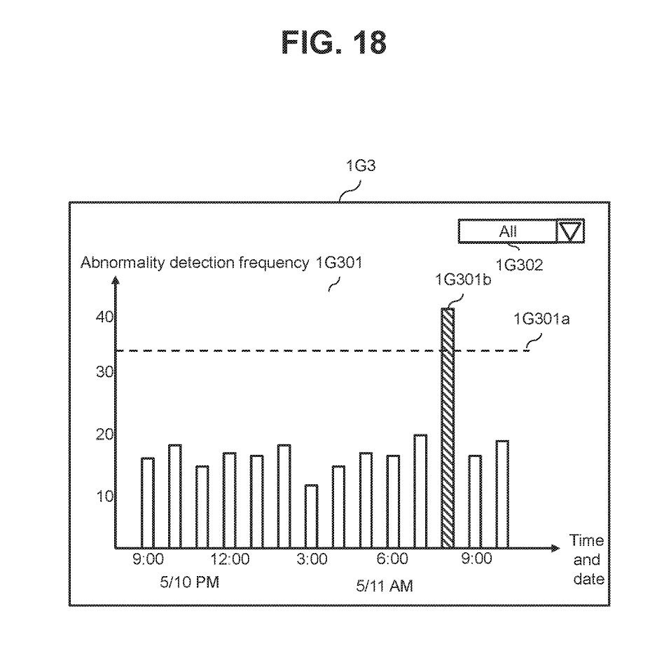

FIG. 18 shows an example of an abnormality detection frequency display screen 1G3. The abnormality detection frequency display screen 1G3 may be displayed by the display unit 121 of the terminal 12. The abnormality detection frequency display screen 1G3 may be used in combination with the log information monitoring screen 1G1 or may be used independently.

The abnormality detection frequency display screen 1G3 may display an abnormality detection frequency graph 1G301 and an abnormality pattern selection box 1G302.

The abnormality detection frequency graph 1G301 may display, in units of a fixed time width, a frequency distribution (histogram) of an abnormality detection frequency related to a pattern specified by the abnormality pattern selection box 1G302. In the example shown in FIG. 18, since “all” is selected in the abnormality pattern selection box 1G302, “all” monitoring target patterns are considered. The abnormality pattern selection box 1G302 may enable selection of various monitoring target patterns or combinations thereof. In addition, when a combination of patterns or all patterns are selected in the abnormality pattern selection box 1G302, color coding or the like may be used to make a breakdown of the selection recognizable.

In the present embodiment, 1 hour is adopted as a bin width (time width) of a frequency distribution. For example, for 9:00 PM on May 12th, the abnormality detection frequency in one bin width (time width) corresponds to a total number of abnormalities detected between 8:30 PM on May 12th and 9:30 PM on May 12th. Moreover, the time width may be changed to a 30-minute unit, a 15-minute unit, or the like in order to meet demands of the system or the operation supervisor.

A threshold 1G301a may be set to the abnormality detection frequency graph 1G301. A location at which the abnormality detection frequency is equal to or higher than the threshold 1G301a may be highlighted as depicted by 1G301b. In the present embodiment, a value that is double the average over the previous one week is set as the threshold 1G301a.

However, the period and the multiple related to the threshold 1G301a may be changed, the operation supervisor may set a fixed value as the threshold 1G301a in advance, or the threshold 1G301a may be configured to fluctuate by learning a fluctuation with a statistical model in consideration of time.

According to the present embodiment, an abnormality can be detected from a log obtained by integrating a plurality of logs. Therefore, a burden placed on the operation supervisor can be reduced.

In addition, it is difficult for the operation supervisor to manually set the window sizes described earlier. For example, setting an excessively long window size creates a risk that a determination of normal may be made in combination with another event series, and setting an excessively short window size creates a risk that, after being combined with another event series, a normal event series may not be output to an end thereof in the section and may result in being determined as an abnormal event series. However, in the present embodiment, since an optimal window size is automatically determined for each monitoring target pattern, high abnormality detection performance (precision and/or recall) can be realized as compared to cases where a fixed window size is used.

In addition, in the present embodiment, instead of simply presenting the fact that an abnormality has occurred, which frequently-appearing series pattern the occurrence of the abnormality is related to and which of the events constituting the frequently-appearing series pattern had occurred normally can be presented in a recognizable mode. Accordingly, instead of simply learning that an abnormality has occurred, an operation supervisor can obtain useful information in order to investigate a cause of the occurrence of the abnormality. In other words, the present embodiment increases the chances of the operation supervisor being able to discover the cause of the abnormality in a shorter period of time.

The embodiment described above merely represents an example for illustrating the present invention, and it is to be understood that the scope of the present invention is not limited to the embodiment. It will be obvious to those skilled in the art that the present invention can be implemented in various other modes without departing from the spirit of the present invention.

What is claimed is:

1. An abnormality detection system for detecting an abnormality of a monitoring target system, the abnormality detection system comprising:
a memory; and
a processor using the memory,
the processor being configured to
(a) convert, based on a prescribed rule, a time-sequential event included in a log output by the monitoring target system into a symbolized event,
(b) learn, based on a normal-time log symbolized in (a), a symbolized event sequence, which appears in a same pattern, as a frequently-appearing pattern; and
(c) detect an occurrence or a nonoccurrence of an abnormality, based on whether not the frequently-appearing pattern is occurring in a monitoring-time log symbolized in (a).

2. The abnormality detection system according to claim 1, wherein
the processor is configured to, in (c),
extract, based on a size of a symbolized event sequence constituting the frequently-appearing pattern, a symbolized event sequence to be a target of detection of whether or not the frequently-appearing pattern has occurred from the symbolized monitoring-time log.

3. The abnormality detection system according to claim 2, wherein
the processor is configured to, in (c),
determine that an abnormality exists when a partial pattern which is a part of the frequently-appearing pattern occurs in the extracted symbolized event sequence that is the detection target and, at the same time, a rest pattern which is a pattern that appears after the partial pattern of the frequently-appearing pattern does not appear regardless of a probability of occurrence of the frequently-appearing pattern including the partial pattern when the partial pattern occurs is equal to or larger than a prescribed threshold.

4. The abnormality detection system according to claim 3, wherein
the processor is configured to
(d) determine a window size of a partial pattern which is a size related to a determination section of an occurrence of a partial pattern from the symbolized monitoring-time log, based on the symbolized normal-time log.

5. The abnormality detection system according to claim 4, wherein
the processor is configured to, in (d),
determine the window size, based on a minimum size among sizes of a plurality of partial patterns for which a probability of occurrence of the frequently-appearing pattern including the partial pattern when the partial pattern occurs is equal to or larger than a prescribed threshold.

6. The abnormality detection system according to claim 4, wherein
the processor is configured to, in (d),
determine the window size, based on event numbers between two prescribed percentiles in a frequency distribution of event numbers of a plurality of frequently-appearing patterns.

7. The abnormality detection system according to claim 4, wherein
the processor is configured to, in (d),
fit a frequency distribution of event numbers of a plurality of frequently-appearing patterns into a prescribed statistical model and determine the window size, based on an event number nearest to a value related to an average value of the statistical model.

8. The abnormality detection system according to claim 3, wherein
the processor is configured to, in (b),
learn, using the symbolized normal-time log, a probability of occurrence of the frequently-appearing pattern including the partial pattern when the partial pattern occurs, as a predictive model related to an LSTM (Long short-term Memory).

9. The abnormality detection system according to claim 3, wherein
the processor is configured to, in (b),
learn, using the symbolized normal-time log, a probability of occurrence of the frequently-appearing pattern including the partial pattern when the partial pattern occurs, as a statistical model.

10. The abnormality detection system according to claim 1, wherein
the processor is configured to, in (a),
generate templates based on a common word shared by a plurality of clusters generated based on an event group of a normal-time log and,
to an event of a monitoring-time log,
allocate, when the event conforms to a certain template, a symbol based on the conforming template,
allocate, when the event does not conform to any of the templates, a symbol indicating an unknown event.

11. The abnormality detection system according to claim 2, wherein
the processor is configured to
(e) generate a GUI which displays a size and an appearance frequency of each frequently-appearing pattern.

12. The abnormality detection system according to claim 2, wherein
the processor is configured to
(f) output the monitoring-time log and generate a GUI which displays an event, in which an abnormality is determined to exist, in a mode enabling the event to be distinguished from other events.

13. The abnormality detection system according to claim 12, wherein
the processor is configured to, in (f),
associate with the event, in which an abnormality is determined to exist, a link to a GUI including information related to the abnormality of the event, and
generate a GUI which displays a frequently-appearing pattern related to the event, in which an abnormality is determined to exist, and a monitoring-time log including the event, as the link destination GUI.

14. An abnormality detection method for detecting an abnormality of a monitoring target system, the abnormality detection method comprising:
(a) convert, based on a prescribed rule, a time-sequential event included in a log output by the monitoring target system into a symbolized event;
(b) learn, based on a normal-time log symbolized in (a), a symbolized event sequence, which appears in a same pattern, as a frequently-appearing pattern; and
(c) detect an occurrence or a nonoccurrence of an abnormality, based on whether not the frequently-appearing pattern is occurring in a monitoring-time log symbolized in (a).
